(19) United States
(12) Patent Application Publication
(10) Pub. No.: US 2020/0186245 A1
(43) Pub. Date: Jun. 11, 2020

(54) DETECTING CODED LIGHT

(71) Applicant: SIGNIFY HOLDING B.V., EINDHOVEN (NL)

(72) Inventor: Paul Henricus Johannes Maria VAN VOORTHUISEN, EINDHOVEN (NL)

(21) Appl. No.: 16/477,396

(22) PCT Filed: Jan. 10, 2018
(86) PCT No.: PCT/EP2018/050543

§ 371 Date: Jul. 11, 2019

(30) Foreign Application Priority Data
Jan. 16, 2017 (EP) 17151544.8

(51) Int. Cl. H04B 10/116; H04B 10/54; H04B 10/61; H04N 5/235

(52) U.S. Cl. CPC H04B 10/116; H04N 5/2353; H04B 10/61; H04B 10/54

(57) ABSTRACT

A decoder for decoding a signal modulated into visible light. The decoder performs operations of: receiving a series of frames captured by a camera, each capturing an image of the light source at a different time index; from each frame, sampling a plurality of portions of the frame that capture part of the light source, and thereby, over the series of frames, obtaining a respective temporal series of samples from each respective one of the portions; for each of the plurality of portions, determining a respective value of a property that smooths out temporal variations within the respective series of samples; using the respective value of property to determine a respective equalization to apply to each of the portions in order to correct for a non-uniformity in the light source; and applying the respective equalization to each of the portions and detecting the coded light signal based thereon.

### TECHNICAL FIELD

The present disclosure relates to the communication of coded light signals embedded in the light emitted by a light source.

### BACKGROUND

Visible light communication (VLC) refers to techniques whereby information is communicated in the form of a signal embedded in the visible light emitted by a light source. VLC is sometimes also referred to as coded light.

The signal is embedded by modulating a property of the visible light, typically the intensity, according to any of a variety of suitable modulation techniques. In some of the simplest cases, the signalling is implemented by modulating the intensity of the visible light from each of multiple light sources with a single periodic carrier waveform or even a single tone (sinusoid) at a constant, predetermined modulation frequency. If the light emitted by each of the multiple light sources is modulated with a different respective modulation frequency that is unique amongst those light sources, then the modulation frequency can serve as an identifier (ID) of the respective light source or its light.

In more complex schemes a sequence of data symbols may be modulated into the light emitted by a given light source. The symbols are represented by modulating any suitable property of the light, e.g. amplitude, modulation frequency, or phase of the modulation. For instance, data may be modulated into the light by means of amplitude keying, e.g. using high and low levels to represent bits or using a more complex modulation scheme to represent different symbols. Another example is frequency keying, whereby a given light source is operable to emit on two (or more) different modulation frequencies and to transmit data bits (or more generally symbols) by switching between the different modulation frequencies. As another possibility a phase of the carrier waveform may be modulated in order to encode the data, i.e. phase shift keying.

In general the modulated property could be a property of a carrier waveform modulated into the light, such as its amplitude, frequency or phase; or alternatively a baseband modulation may be used. In the latter case there is no carrier waveform, but rather symbols are modulated into the light as patterns of variations in the brightness of the emitted light. This may for example comprise modulating the intensity to represent different symbols, or modulating the mark:space ratio of a pulse width modulation (PWM) dimming waveform, or modulating a pulse position (so-called pulse position modulation, PPM). The modulation may involve a coding scheme to map data bits (sometimes referred to as user bits) onto such channel symbols. An example is a conventional Manchester code, which is a binary code whereby a user bit of value 0 is mapped onto a channel symbol in the form of a low-high pulse and a user bit of value 1 is mapped onto a channel symbol in the form of a high-low pulse. Another example coding scheme is the so-called Ternary Manchester code developed by the applicant (WO2012/052935 A1).

Based on the modulations, the information in the coded light can be detected using any suitable light sensor. This can be either a dedicated photocell (point detector), or a camera comprising an array of photocells (pixels) and a lens for forming an image on the array. E.g. the camera may be a general purpose camera of a mobile user device such as a smartphone or tablet. Camera based detection of coded light is possible with either a global-shutter camera or a rolling-shutter camera. E.g. rolling-shutter readout is typical to mobile CMOS image sensors found in everyday mobile user devices such as smartphones and tablets). In a global-shutter camera the entire pixel array (entire frame) is captured at the same time, and hence a global shutter camera captures only one temporal sample of the light from a given luminaire per frame. In a rolling-shutter camera on the other hand, the frame is divided into lines in the form of horizontal rows and the frame is exposed line-by-line in a temporal sequence, each line in the sequence being exposed at a slightly later time than the last. Each line therefore captures a sample of the signal at a different moment in time. Hence while rolling-shutter cameras are generally the cheaper variety and considered inferior for purposes such as photography, for the purpose of detecting coded light they have the advantage of capturing more temporal samples per frame, and therefore a higher sample rate for a given frame rate. Nonetheless coded light detection can be achieved using either a global-shutter or rolling-shutter camera as long as the sample rate is high enough compared to the modulation frequency or data rate (i.e. high enough to detect the modulations that encode the information).

Coded light is often used to embed a signal in the light emitted by an illumination source such as an everyday luminaire, e.g. room lighting or outdoor lighting, thus allowing the illumination from the luminaires to double as a carrier of information. The light thus comprises both a visible illumination contribution for illuminating a target environment such as room (typically the primary purpose of the light), and an embedded signal for providing information into the environment (typically considered a secondary function of the light). In such cases, the modulation is typically performed at a high enough frequency so as to be beyond human perception, or at least such that any visible temporal light artefacts (e.g. flicker and/or strobe artefacts) are weak enough not to be noticeable or at least to be tolerable to humans. Thus the embedded signal does not affect the primary illumination function, i.e. so the user only perceives the overall illumination and not the effect of the data being modulated into that illumination. E.g. Manchester coding is an example of a DC free code, wherein the power spectral density goes to zero at zero Hertz, with very little spectral content at low frequencies, thus reducing visible flicker to a practically invisible level. Ternary Manchester is DC² free, meaning not only does the power spectral density go to zero at zero Hertz, but the gradient of the power spectral density also goes to zero, thus eliminating visible flicker even further.

Coded light can be used in a variety of possible applications. For instance a different respective ID can be embedded into the illumination emitted by each of the luminaires in a given environment, e.g. those in a given building, such that each ID is unique at least within the environment in question. E.g. the unique ID may take the form of a unique modulation frequency or unique sequence of symbols. This in itself can then enable any one or more of a number of applications. For instance, one application is to provide information from a luminaire to a remote control unit for control purposes, e.g. to provide an ID distinguishing it amongst other such luminaires which the remote unit can control, or to provide status information on the luminaire (e.g. to report errors, warnings, temperature, operating time, etc.). For example the remote control unit may take the form of a mobile user terminal such as a smartphone, tablet, smartwatch or smart-glasses equipped with a light sensor such as a built-in camera. The user can then direct the sensor toward a particular luminaire or subgroup of luminaires so that the mobile device can detect the respective ID(s) from the emitted illumination captured by the sensor, and then use the detected ID(s) to identify the corresponding one or more luminaires in order to control it/them (e.g. via an RF back channel). This provides a user-friendly way for the user to identify which luminaire or luminaires he or she wishes to control. The detection and control may be implemented by a lighting control application or “app” running on the user terminal.

In another application the coded light may be used in commissioning. In this case, the respective IDs embedded in the light from the different luminaires can be used in a commissioning phase to identify the individual illumination contribution from each luminaire.

In another example, the identification can be used for navigation or other location-based functionality, by mapping the identifier to a known location of a luminaire or information associated with the location. In this case, there is provided a location database which maps the coded light ID of each luminaire to its respective location (e.g. coordinates on a map or floorplan), and this database may be made available to mobile devices from a server via one or more networks such as a wireless local area network (WLAN) or mobile cellular network, or may even be stored locally on the mobile device. Then if the mobile device captures an image or images containing the light from one or more of the luminaires, it can detect their IDs and use these to look up their locations in the location database in order to estimate the location of the mobile device based thereon. E.g. this may be achieved by measuring a property of the received light such as received signal strength, time of flight and/or angle of arrival, and then applying technique such as triangulation, trilateration, multilateration or fingerprinting; or simply by assuming that the location of the nearest or only captured luminaire is approximately that of the mobile device. In some cases such information may be combined with information from other sources, e.g. on-board accelerometers, magnetometers or the like, in order to provide a more robust result. The detected location may then be output to the user through the mobile device for the purpose of navigation, e.g. showing the position of the user on a floorplan of the building. Alternatively or additionally, the determined location may be used as a condition for the user to access a location based service. E.g. the ability of the user to use his or her mobile device to control the lighting (or another utility such as heating) in a certain region or zone (e.g. a certain room) may be made conditional on the location of his or her mobile device being detected to be within that same region (e.g. the same room), or perhaps within a certain control zone associated with the lighting in question. Other forms of location-based service may include, e.g., the ability to make or accept location-dependent payments.

As another example application, a database may map luminaire IDs to location specific information such as information on a particular museum exhibit in the same room as a respective one or more luminaires, or an advertisement to be provided to mobile devices at a certain location illuminated by a respective one or more luminaires. The mobile device can then detect the ID from the illumination and use this to look up the location specific information in the database, e.g. in order to display this to the user of the mobile device. In further examples, data content other than IDs can be encoded directly into the illumination so that it can be communicated to the receiving device without requiring the receiving device to perform a look-up.

Thus coded light has various commercial applications in the home, office or elsewhere, such as a personalized lighting control, indoor navigation, location based services, etc.

As mentioned above, coded light can be detected using an everyday “rolling shutter” type camera, as is often integrated into an everyday mobile user device like a mobile phone or tablet. In a rolling-shutter camera, the camera's image capture element is divided into a plurality of horizontal lines (i.e. rows) which are exposed in sequence line-by-line. That is, to capture a given frame, first one line is exposed to the light in the target environment, then the next line in the sequence is exposed at a slightly later time, and so forth. Each line therefore captures a sample of the signal at a different moment in time (typically with the pixels from each given line being condensed into a single sample value per line). Typically the sequence “rolls” in order across the frame, e.g. in rows top to bottom, hence the name “rolling shutter”. When used to capture coded light, this means different lines within a frame capture the light at different moments in time and therefore, if the line rate is high enough relative to the modulation frequency, at different phases of the modulation waveform. Thus the rolling-shutter readout causes fast temporal light modulations to translate into spatial patterns in the line-readout direction of the sensor, from which the encoded signal can be decoded.

### SUMMARY

There is a problem with coded light detection in that the light source does not always emit light in a spatially uniform manner. For instance, typically the coded-light emitting lamp of a luminaire will be placed behind a diffuser which evens out the intensity of the DC illumination over the surface of the diffuser (leaving only the modulations caused by the embedded alternating signal). When the camera of the coded light detector “sees” the luminaire, it sees this uniform level across the surface of the luminaire, such that any variation in the emitted light can be assumed to be the modulation due to the embedded signal, and the signal can be therefore be decoded based on this. However, in practice, sometimes coded light detection is required based on a view of a lamp that is not behind a diffuser, or sometimes a diffuser is not perfect in evening out the illumination level. Similar issues could occur with any type of coded light source. Hence it would be desirable to provide a decoder with an equalization function to remove an effect of a spatial non-uniformity from an image of a light source prior to coded light detection.

To address this, the present disclosure provides a technique based on taking a temporal series samples of each of a plurality of portions of the frame area (e.g. of each pixel or line) over a series frames, and then evaluating the samples so as, for each of the portions (e.g. each pixel or line), to establish a property such as the average or envelope that smooths out temporal variations in the respective series of samples. Each of the frame portions (e.g. pixels or lines) can then be equalized based on the establish property.

According to one aspect disclosed herein, there is provided a device comprising a decoder for decoding a signal modulated into visible light emitted by a light source, the decoder being configured to perform operations of: receiving a series of frames captured by a camera, each of said series of frames capturing an image of the light source at a different time index; from each of said series of frames, sampling a plurality of portions of the frame that capture part of the light source, and thereby, over the series of frames, obtaining a respective temporal series of samples from each respective one of the portions; for each of said plurality of portions, determining a respective value of a property that smooths out temporal variations within the respective series of samples; using the respective value of said property to determine a respective equalization to apply to each of the portions in order to correct for a non-uniformity in the light source; and applying the respective equalization to each of said portions and detecting the coded light signal based thereon.

E.g. each of said portions may be a respective one of the lines of a rolling-shutter camera, sampled by combining individual pixels values from the respective line. Alternatively each of said portions may be a pixel, or a group of pixels in a two-dimensional array of such groups.

In embodiments, said property may be an average of the respective series of samples.

However, a disadvantage of using the average is that it requires a relatively large number of samples to obtain a reliably representative value. As identified herein, a property which requires a smaller set of samples to be reliable is the envelope of modulation.

Hence in embodiments, said property comprises an upper or lower envelope of the respective series of samples.

Preferred embodiments are based around an observation that: the ratio of the upper to the lower envelope oscillates across the frame area, and in regions of the frame area where the ratio of the upper to the lower envelope is maximum, this means the upper and lower envelopes are both good, i.e. both accurate indications of amplitude of the modulation in the signal (and hence in these regions the measured ratio is close to its true value). But in regions of the frame where the ratio of the upper to the lower envelope is towards its minimum, this is because one of the upper and lower envelopes is bad, i.e. they are not representative of the amplitude of the modulation.

Therefore in embodiments, the decoder may be configured to perform the determination of said equalization by, for each of said plurality of portions: determining one of the upper or lower envelope to be valid, and determining the equalization to apply based on the valid envelope.

“Valid” here means that the decoder determines one of the two envelopes to be a more representative indication of the true amplitude of the modulation than the other.

In embodiments, the decoder may be configured to perform the determination of said equalization by: a) evaluating a metric comparing the upper envelope to the lower envelope across each of the plurality of portions, b) based thereon determining a value of said metric at which said metric indicates that the upper envelope is greatest compared to the lower envelope, and c) reconstructing one of the upper or lower envelopes across said plurality of portions, by, where said one of the upper or lower envelopes is not the valid envelope, reconstructing said one of the upper or lower envelopes based on the other of the upper and lower envelopes and the value at which said metric indicates the greatest difference between the upper and lower envelopes, wherein the equalization is performed based on the reconstructed upper or lower envelope.

Note that a metric indicative of a difference between the upper and lower envelopes, as referred to herein, does not limit to a subtractive difference. Indeed, in embodiments, said metric is a ratio between the upper and lower envelopes. That is, if reconstructing the lower envelope, then for parts where the lower envelope is valid the sampled lower envelope itself is used to form those parts of the reconstructed lower envelope; but for parts where the upper envelope is valid, then in those parts the reconstructed lower envelope is reconstructed by dividing the sampled upper envelope by the maximum ratio of the sampled upper envelope to the sampled lower envelope (or equivalently multiplying it by the minimum ratio of the sampled lower envelope to the sampled upper envelope). Or, when the upper envelope is being reconstructed, then for parts where the upper envelope is valid the sampled upper envelope itself is used to form those parts of the reconstructed upper envelope; but for parts where the lower envelope is valid, then in those parts the reconstructed upper envelope is reconstructed by multiplying the sampled lower envelope by the maximum ratio of the sampled upper envelope to the sampled lower envelope (or equivalently dividing it by the minimum ratio of the sampled lower envelope to the sampled upper envelope).

Hence in embodiments, the decoder may be configured to perform operations a) to c) by: a) determining a ratio of the upper to the lower envelope for each of the plurality of portions wherein the ratio oscillates in space across the plurality of portions, b) determining a maximum of said ratio across the plurality of portions, and c) reconstructing one of the upper or lower envelopes across said plurality of portions, by, where said one of the upper or lower envelopes is not the valid envelope, reconstructing said one of the upper or lower envelopes by multiplying or dividing, accordingly, the other of the upper and lower envelopes by the determined maximum of said ratio, wherein the equalization is performed based on the reconstructed upper or lower envelope.

In further embodiments, the decoder may be configured to perform the determination as to which of the upper and lower envelopes is valid by: across the plurality of portions, determining points at which a ratio of the upper to the lower envelope is minimum, and for each respective one of said points, determining which is spatially closest to the respective point out of: i) a feature of the lower envelope whereby, from one of the portions to an adjacent one of said portions, the time index corresponding to the greatest value amongst the respective series of samples differs, in which case the upper envelope is determined to be the valid envelope in a region around the respective point, or ii) a feature of the upper envelope whereby, from one of the portions to an adjacent one of said portions, the time index corresponding to the greatest value amongst the respective series of samples differs, in which case the lower envelope is determined to be the valid envelope in a region around the respective point.

That is, for each of the frames (each frame time index), the decoder determines a separate spatial signal across the frame area (e.g. formed in the lines of a rolling-shutter camera or across the pixels of the frame). I.e. each spatial signal is made up of one of the samples from each of said portions (e.g. each line or pixel) across the frame as sampled at a particular one of the time indices (a particular frame). This could therefore also be referred to as a per-frame spatial signal. Further, where the ratio of the upper to the lower envelope is at its minimum (or equivalently where the ratio of the lower to the upper envelope is maximum, or such like, i.e. where the upper and lower envelopes are most different), then this means one of the two envelopes is a good indication of the modulation amplitude but the other is poor. It is recognized herein that at this point, there will be found a “take-over” feature. This take-over feature could be one of two things. If the lower envelope is the envelope that is bad, the take-over feature is a point where there a change-over as to which of the spatial signals from the different frames is the lowest valued. If on the other hand the upper envelope is the one that is bad, the take-over feature is a point where there is a change-over as to which of the spatial signals from the different frames is highest valued. That is, at the point where an envelope is bad, at least one take over feature will be present in the set of per-frame spatial signals. In case the upper envelope is bad the maximum is taken over by another per-frame spatial signal. In case the case lower envelope is bad on the other hand, the minimum is taken over by another of the per-frame signals. This will become more apparent when discussed by way of example with reference to FIG. 16 later. Embodiments exploit this phenomenon in order to identify which envelope to use at which positions to construct the equalization function.

However, there are situations where both the maximum is taken over by another signal and the minimum is taken over by another signal. In that case, the slope difference for each take over feature can be involved in the selection. The one with the highest value is the bad one.

Hence in embodiments, the decoder may be configured so as, when the features of both i) and ii) occur at the same point, to determine for each of i) and ii) a change in slope of the signal from the time index of the one portion to the time index of the adjacent portion, and to select as the valid envelope that one of the upper and lower envelopes which has the greatest change in slope.

This advantageously improves reliability of the equalization and therefore the decoding, by resolving a potential ambiguity as to the selection of whether to declare the upper or the lower envelope as valid for equalization purposes.

In embodiments, the device further comprises a motion compensator arranged to compensate for relative motion between the light source and the camera. This advantageously ensures that the plurality of portions (e.g. lines or pixels) in each frame in the series is aligned in space with the corresponding plurality of portions (e.g. lines or pixels) of each other of the frames in the series.

In embodiments, the device may comprise the camera. Alternatively the camera may be external to the device.

According to another aspect disclosed herein, there is provided a system further comprising the camera and the light source.

In embodiments, the light source may take the form of a luminaire and said light may take the form of illumination for illuminating an environment.

According to another aspect disclosed herein, there is provided a method of decoding a signal modulated into visible light emitted by a light source, the method comprising: receiving a series of frames captured by a camera, each of said series of frames capturing an image of the light source at a different time index; from each of said series of frames, sampling a plurality of portions of the frame that capture part of the light source, and thereby, over the series of frames, obtaining a respective temporal series of samples from each respective one of the portions; for each of said plurality of portions, determining a respective value of a property that smooths out temporal variations within the respective series of samples; using the respective value of said property to determine a respective equalization to apply to each of the portions in order to correct for a non-uniformity in the light source; and applying the respective equalization to each of said portions and detecting the coded light signal based thereon.

According to another aspect disclosed herein, there is provided a computer program product for decoding a signal modulated into visible light emitted by a light source, the computer program product comprising code embodied on a computer-readable medium and/or being downloadable therefrom, and the code being configured to perform operations of: receiving a series of frames captured by a camera, each of said series of frames capturing an image of the light source at a different time index; from each of said series of frames, sampling a plurality of portions of the frame that capture part of the light source, and thereby, over the series of frames, obtaining a respective temporal series of samples from each respective one of the portions; for each of said plurality of portions, determining a respective value of a property that smooths out temporal variations within the respective series of samples; using the respective value of said property to determine a respective equalization to apply to each of the portions in order to correct for a non-uniformity in the light source; and applying the respective equalization to each of said portions and detecting the coded light signal based thereon.

In embodiments, the method or computer program product may further comprise steps, or be configured to perform operations, respectively, corresponding to any of the device or system features disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a coded light communication system;

FIG. 2 is a schematic representation of a frame captured by a rolling shutter camera;

FIG. 2a is a timing diagram showing the line readout of a rolling shutter camera;

FIG. 3 schematically illustrates an image capture element of a rolling-shutter camera;

FIG. 4 schematically illustrates the capture of modulated light by rolling shutter;

FIG. 5 shows the x and y axes of a frame;

FIG. 6 is an example plot of a received coded light signal as a function of rolling-shutter line y, with a sinewave being used as an example of the coded light signal;

FIG. 7 is a plot of the signal of FIG. 6 after equalization;

FIG. 8 is a plot of multiple instances of a received sinewave as captured in different respective frames, again with a sinewave being used as an example of the coded light signal;

FIG. 9 is a plot of the upper and lower envelopes of the signal instances of FIG. 8;

FIG. 10 is a plot of the signal of FIGS. 8 and 9 as equalized based on the lower envelope of FIG. 9;

FIG. 11 is a plot of another example of multiple instances of a received coded light signal as captured in different respective frames, again with a sinewave being used as an example of the coded light signal;

FIG. 12 is a plot of the upper and lower envelopes of the signal instances of FIG. 11;

FIG. 13 is a plot of the signal of FIGS. 11 and 12 as equalized based on the lower envelope of FIG. 12;

FIG. 14 is a plot of the ratio of the upper and lower envelopes of FIG. 12;

FIG. 15 is a schematic block diagram illustrating an algorithm for constructing a valid envelope for equalizing a received coded light signal;

FIG. 16 shows a detail of the plot of FIG. 12;

FIG. 17 shows a further detail of the plot of FIGS. 12 and 16;

FIG. 18 is a plot of the signal of FIGS. 11 and 12 as equalized based on the valid envelope generated according to the algorithm of FIG. 15 or process of FIG. 19; and

FIG. 19 is a flow chart illustrating a process for constructing a valid envelope for equalizing a received coded light signal.

### DETAILED DESCRIPTION OF EMBODIMENTS

In VLC (i.e. coded light) systems, a visible light source acts as the carrier for modulation, which can be captured in an image of the light source taken by a camera. However, sometimes the light source is such that the carrier illumination itself is non-uniform, thus adding a spatially-varying offset in the image. It would be desirable to be able to separate this offset from the true modulation of the actual signal embedded in the light. Accordingly, the following describes a decoder comprising an equalizer for undoing a non-uniformity from the captured image of a non-uniform light source in order to extract the modulation from the captured images. After this step the carrier has become uniform for all pixels and detection of the modulation becomes straight forward. Note that there are no restrictions on the actual pattern of the non-uniformity—i.e. the equalizer can handle any arbitrary function of space, and does not rely on attempting to analytically model any particular assumed shape of non-uniformity.

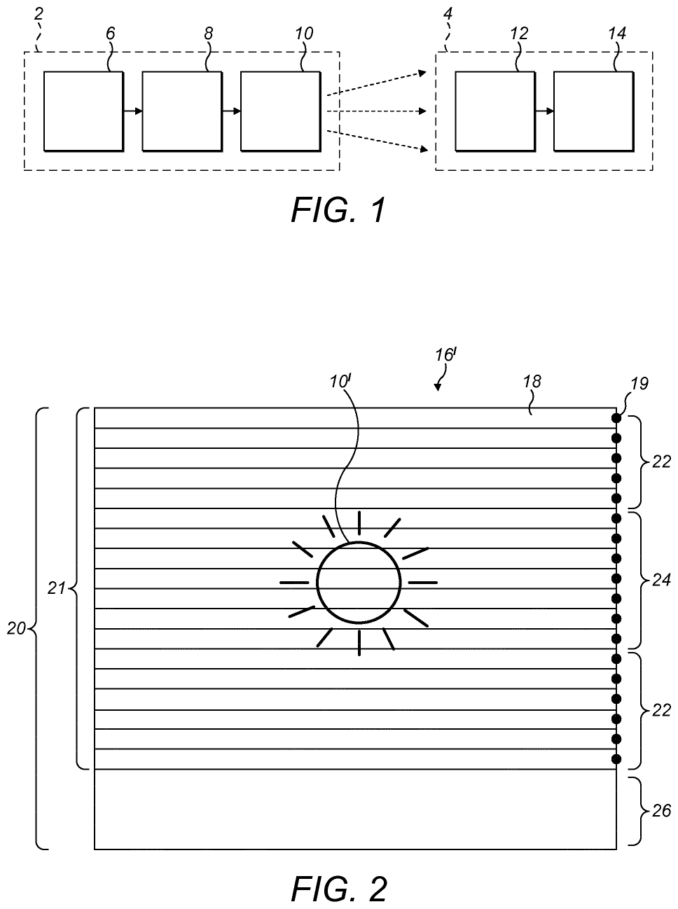

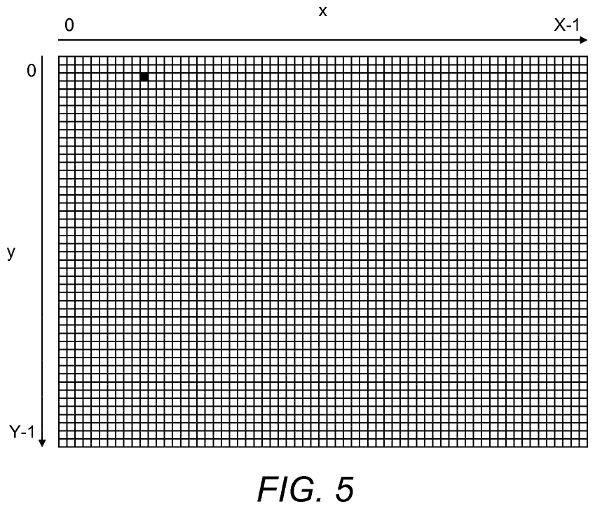

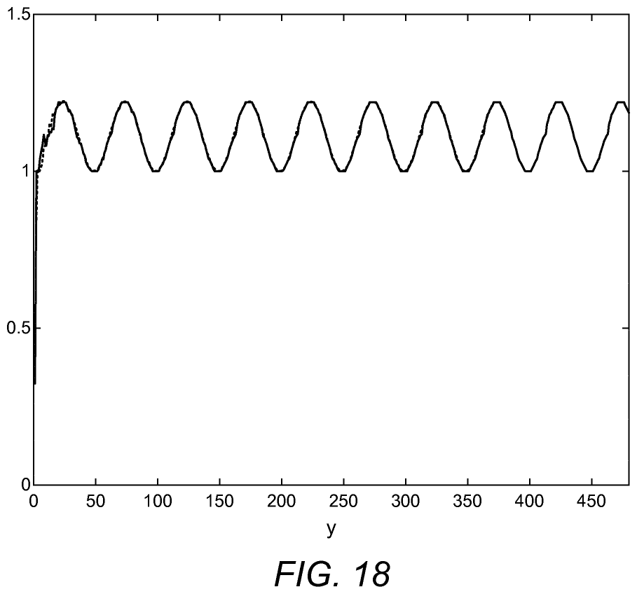

First there will be described, by reference to FIGS. 1 to 4, an example system in which the disclosed techniques may be implemented. There then follows an example equalization technique described by reference to FIGS. 5 to 19.

FIG. 1 gives a schematic overview of a system for transmitting and receiving coded light. The system comprises a transmitter 2 and a receiver 4. For example the transmitter 2 may take the form of a luminaire, e.g. mounted on the ceiling or wall of a room, or taking the form of a free-standing lamp, or an outdoor light pole. The receiver 4 may for example take the form of a mobile user terminal such as a smart phone, tablet, laptop computer, smartwatch, or a pair of smart-glasses.

The transmitter 2 comprises a light source 10 and a driver 8 connected to the light source 10. In the case were the transmitter 2 comprises a luminaire, the light source 10 takes the form of an illumination source (i.e. lamp) configured to emit illumination on a scale suitable for illuminating an environment such as a room or outdoor space, in order to allow people to see objects and/or obstacles within the environment and/or find their way about. The illumination source 10 may take any suitable form such as an LED-based lamp comprising a string or array of LEDs, or an incandescent lamp such as filament bulb. The transmitter 2 also comprises an encoder 6 coupled to an input of the driver 8, for controlling the light source 10 to be driven via the driver 8. Particularly, the encoder 6 is configured to control the light source 10, via the diver 8, to modulate the illumination it emits in order to embed a cyclically repeated coded light message. Any suitable known modulation technique may be used to do this. In embodiments the encoder 6 is implemented in the form of software stored on a memory of the transmitter 2 and arranged for execution on a processing apparatus of the transmitter (the memory on which the software is stored comprising one or more memory units employing one or more storage media, e.g. EEPROM or a magnetic drive, and the processing apparatus on which the software is run comprising one or more processing units). Alternatively it is not excluded that some or all of the encoder 6 could be implemented in dedicated hardware circuitry, or configurable or reconfigurable hardware circuitry such as a PGA or FPGA.

The receiver 4 comprises a camera 12 and a coded light decoder 14 coupled to an input from the camera 12 in order to receive images captured by the camera 12. The receiver 4 also comprises a controller 13 which is arranged to control the exposure of the camera 12. In embodiments, the decoder 14 and controller 13 are implemented in the form of software stored on a memory of the receiver 4 and arranged for execution on a processing apparatus of the receiver 4 (the memory on which the software is stored comprising one or more memory units employing one or more storage media, e.g. EEPROM or a magnetic drive, and the processing apparatus on which the software is run comprising one or more processing units). Alternatively it is not excluded that some or all of the decoder 14 and/or controller 13 could be implemented in dedicated hardware circuitry, or configurable or reconfigurable hardware circuitry such as a PGA or FPGA.

The encoder 6 is configured to perform the transmit-side operations in accordance with embodiments disclosed herein, and the decoder 14 and controller 13 are configured to perform the receive-side operations in accordance with the disclosure herein. Note also that the encoder 6 need not necessarily be implemented in the same physical unit as the light source 10 and its driver 8. In embodiments the encoder 6 may be embedded in a luminaire along with the driver and light source. Alternatively the encoder 6 could be implemented externally to the luminaire 4, e.g. on a server or control unit connected to the luminaire 4 via any one or more suitable networks (e.g. via the internet, or via a local wireless network such as a Wi-Fi or ZigBee, 6LowPAN or Bluetooth network, or via a local wired network such as an Ethernet or DMX network). In the case of an external encoder, some hardware and/or software may still be provided on board the luminaire 4 to help provide a regularly timed signal and thereby prevent jitter, quality of service issues, etc.

Similarly the coded light decoder 14 and/or controller 13 are not necessarily implemented in the same physical unit as the camera 12. In embodiments the decoder 14 and controller 13 may be incorporated into the same unit as the, e.g. incorporated together into a mobile user terminal such as a smartphone, tablet, smartwatch or pair of smart-glasses (for instance being implemented in the form of an application or “app” installed on the user terminal). Alternatively, the decoder 14 and/or controller 13 could be implemented on an external terminal. For instance the camera 12 may be implemented in a first user device such as a dedicated camera unit or mobile user terminal like a smartphone, tablet, smartwatch or pair of smart glasses; whilst the decoder 14 and controller 13 may be implemented on a second terminal such as a laptop, desktop computer or server connected to the camera 12 on the first terminal via any suitable connection or network, e.g. a one-to-one connection such as a serial cable or USB cable, or via any one or more suitable networks such as the Internet, or a local wireless network like a Wi-Fi or Bluetooth network, or a wired network like an Ethernet or DMX network.

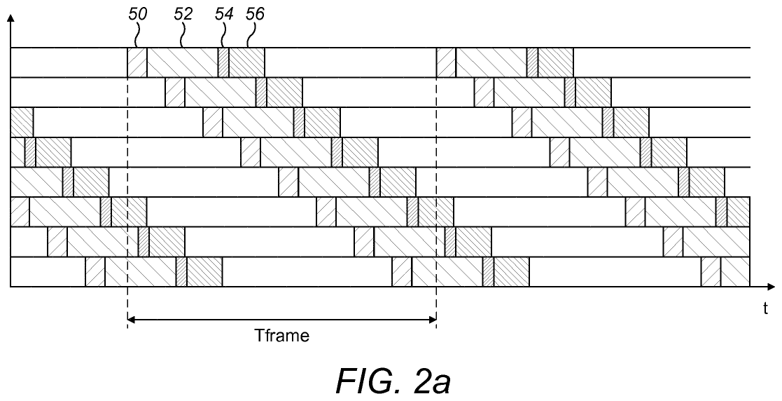

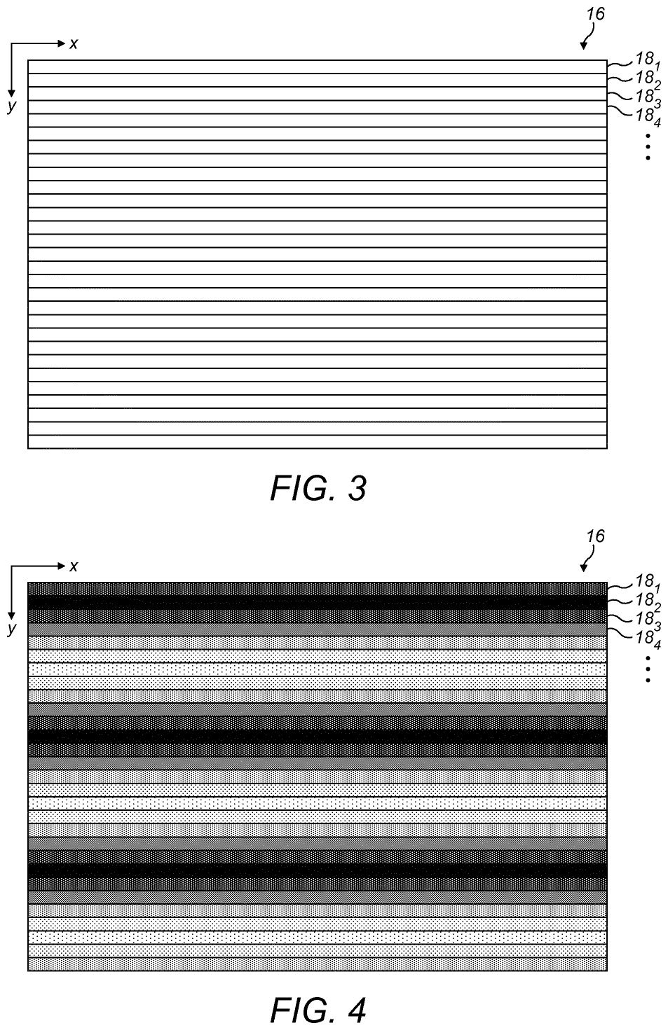

FIG. 3 represents the image capture element 16 of the camera 12, which takes the form of a rolling-shutter camera. The image capture element 16 comprises an array of pixels for capturing signals representative of light incident on each pixel, e.g. typically a square or rectangular array of square or rectangular pixels. In a rolling-shutter camera, the pixels are arranged into a plurality of lines in the form of horizontal rows 18. To capture a frame each line is exposed in sequence, each for a successive instance of the camera's exposure time Texp. In this case the exposure time is the duration of the exposure of an individual line. Note of course that in the context of a digital camera, the terminology “expose” or “exposure” does not refer to a mechanical shuttering or such like (from which the terminology historically originated), but rather the time when the line is actively being used to capture or sample the light from the environment. Note also that a sequence in the present disclosure means a temporal sequence, i.e. so the exposure of each line starts at a slightly different time. This does not exclude that optionally the exposure of the lines may overlap in time, i.e. so the exposure time Texp is longer than the line time (1/line rate), and indeed typically this is more often the case. For example first the top row 18₁ begins to be exposed for duration Texp, then at a slightly later time the second row down 18₂ begins to be exposed for Texp, then at a slightly later time again the third row down 18₃ begins to be exposed for Texp, and so forth until the bottom row has been exposed. This process is then repeated in order to expose a sequence of frames. An example of this is illustrated in FIG. 2a, where the vertical axis represents different lines 18 of the rolling-shutter image capture element, and the horizontal axis represents time (t). For each line, reference numeral 50 labels the reset time, reference numeral 52 labels the exposure time Texp, reference numeral 54 labels the readout time, and reference numeral 56 labels the charge transfer time. Tframe is the frame period, i.e. l/framerate.

Coded light can be detected using a conventional video camera of this type. The signal detection exploits the rolling shutter image capture, which causes temporal light modulations to translate to spatial intensity variations over successive image rows.

This is illustrated schematically in FIG. 4. As each successive line 18 is exposed, it is exposed at a slightly different time and therefore (if the line rate is high enough compared to the modulation frequency) at a slightly different phase of the modulation. Thus each line 18 is exposed to a respective instantaneous level of the modulated light. This results in a pattern of stripes which undulates or cycles with the modulation over a given frame. Based on this principle, the decoder 14 is able to detect coded light components modulated into light received by the camera 12.

For coded light detection, a camera with a rolling-shutter image sensor has an advantage over global-shutter readout (where a whole frame is exposed at once) in that the different time instances of consecutive sensor lines causes fast light modulations to translate to spatial patterns as discussed in relation to FIG. 4. However unlike shown in FIG. 4, the light (or at least the useable light) from a given light source 4 does not necessarily cover the area of the whole image capture element 16, but rather only a certain footprint. As a consequence, the shorter the vertical spread of a captured light footprint, the longer the duration over which the coded light signal is detectable. In practice, this means only a temporal fragment of the entire coded light signal can be captured within a single frame, such that multiple frames are required in order to capture sufficient shifted signal fragments to recover the data embedded in the coded light. The smaller the signal fragment in each frame, the more captured frames are necessary before data recovery is possible.

Referring to FIG. 2, the camera 12 is arranged to capture a series of frames 16′, which if the camera is pointed towards the light source 10 will contain an image 10′ of light from the light source 10. As discussed, the camera 12 is a rolling shutter camera, which means it captures each frame 16′ not all at once (as in a global shutter camera), but by line-by-line in a sequence of lines 18. That is, each frame 16 is divided into a plurality of lines 18 (the total number of lines being labelled 20 in FIG. 2), each spanning across the frame 16 and being one or more pixels thick (e.g. spanning the width of the frame 16 and being one or more pixels high in the case of horizontal lines). The capture process begins by exposing one line 18, then the next (typically an adjacent line), then the next, and so forth. For example the capturing process may roll top-to-bottom of the frame 16′, starting by exposing the top line, then next line from top, then the next line down, and so forth. Alternatively it could roll bottom-to-top, or even side to side. Of course if the camera 12 is included in a mobile or movable device such that it can be oriented in different directions, the orientation of the lines relative to an external frame of reference is variable. Hence as a matter of terminology, the direction perpendicular to the lines in the plane of the frame (i.e. the rolling direction, also referred to as the line readout direction) will be referred to as the vertical direction; whilst the direction parallel to the lines in the plane of the frame 16′ will be referred to as the horizontal direction.

To capture a sample for the purpose of detecting coded light, some or all of the individual pixels samples of each given line 18 are combined into a respective combined sample 19 for that line (e.g. only the “active” pixels that usefully contribute to the coded light signal are combined, whilst the rest of the pixels from that line are discarded). For instance the combination may be performed by integrating or averaging the pixel values, or by any other combination technique. Alternatively a certain pixel could be taken as representative of each line. Either way, the samples from each line thus form a temporal signal sampling the coded light signal at different moments in time, thus enabling the coded light signal to be detected and decoded from the sampled signal.

For completeness, note that the frame 16 may also include some blanking lines 26. Typically the line rate is somewhat higher than strictly needed for all active lines: the actual number of lines of the image sensor). The clock scheme of an image sensor uses the pixel clock as the highest frequency, and framerate and line rate are derived from that. This typically gives some horizontal blanking every line, and some vertical blanking every frame.

Note also, as well as dedicated rolling-shutter cameras, there also exist CMOS imagers that support both rolling shutter and global shutter modes. E.g. these sensors are also used in some 3D range cameras, such as may soon be incorporated in some mobile devices. The term “rolling-shutter camera” as used herein refers to any camera having rolling shutter capability, and does not necessarily limit to a camera that can only perform rolling-shutter capture.

The techniques disclosed herein can be applied to either rolling-shutter capture or global shutter capture. Nonetheless, details above are described to provide context for embodiments of the present disclosure which make use of rolling-shutter capture.

Conventional VLC solutions only use diffused light sources. When using a diffused light source, the source appears in the captured image as a uniform source in which modulation is present. If indeed the diffuser does evenly diffuse the light such that the source appears uniformly (apart from the modulation), then the detection of the modulation is straightforward. However, in practice luminaire designs are in many cases not diffused, or even if a diffuser is present the diffusion may not be completely uniform. Consequently, attempting to extract the modulation from such sources leads to problems with the reliability of the detection. To address this, the following provides an equalisation technique by which the uniformity can be restored, such that detection of the modulated waveform becomes more reliable. By using the disclosed equalisation technique the reliability of the coded light detection becomes independent of the luminaire design.

The disclosed technique is based on extracting a specific modulation property, for each relevant camera pixel or line, which can be used to determine the equalisation to apply on a per pixel or per line basis. Preferably, it is desirable to use a property which can be detected in short time. It turns out that the envelope of the modulation is a good choice. When this property is known for each pixel or line of the captured image then the equalization can be performed. The end result is a set of modulated pixel or lines superimposed on a DC carrier where the DC value is uniform over all relevant pixels or lines.

Consider a camera image consisting of X times Y pixels along the x and y axes respectively, as illustrated in FIG. 5. The camera lines 18 run in parallel with the x-axis. When a uniform DC light source 10 is observed by a rolling-shutter camera 12, ideally every pixel will end up at the same value. When modulation is added to the light source 10, the pixels on one line 18 represent a certain timestamp of the continuous time signal due to the rolling shutter mechanism. Suppose the light emitted by the coded light source 10 is modulated with a signal s. The normalized integral intensity I becomes:

I(t)=1+s₍ₜ₎

If the exposure time of the camera 12 is much shorter than the modulation frequency, then for a rolling-shutter camera one can define the following:

P_{(x,y)}=λ(1+s_{(nTline)})

where P is the sampled pixel value, Tline is l/linerate (one over the line rate), and nTline is the discrete time axis (where n=0, 1, 2 . . . ). When using a camera sensor without blanking time, the light intensity sampled at time nTline on the time axis corresponds to line position y=n modulo y_size, where n is the discrete time axis and y_size is the vertical size of the frame area (i.e. number of lines). The factor λ represents the light portion as perceived by a certain pixel. If the source 10 is uniform, λ is fixed for all lines and every pixel on the line. In this situation the modulation can be readily obtained by detecting the fixed DC and subtract this from all pixels.

However, in practice light sources 10 are not always uniform. A consequence of this is that λ becomes dependent on spatial position within the frame area. The sampled pixel value P for a non-uniform source therefore becomes:

P_{(x,y)}=λ_{(x,y)}(1+s_{(nTline)})

Neighbouring λ values can have low correlation in some cases, depending on the optical design of the lamp. In such a case it is not trivial to extract the modulation from images.

As a general solution for this, an equalisation method is presented which does not rely on correlation between the λ values. The purpose of the equaliser is to scale the pixel values P_{(x,y)} by a scale factor E_{(x,y)} such that λ_{(x,y)}E_{(x,y)} becomes fixed for every pixel (the non-uniformity is a multiplicative distortion so one can undo it by multiplication or division). After equalisation the source is DC-uniform, or in other words, the carrier has a fixed value for every pixel, with the only variation remaining being due to the modulation of the coded light signal itself. I.e. the scale factor E as a function of space provides an equalization function for undoing the effect of the non-uniformity λ in the light source 10.

Accordingly the decoder 14 is configured to determine the equalization function E_{(x,y)} based on techniques that will be described shortly, and to then apply the equalization function E_{(x,y)} across the pixel values P_{(x,y)} of the frame area 16, i.e. applying the respective equalization E_{(x,y)} for each position to the sample captured at that position, in order to cancel the spatially-varying effect of the non-uniformity λ_{(x,y)}. For a multiplicative scale factor, this means multiplying each of the pixel values P_{(x,y)} by the respective scale factor E_{(x,y)} for the respective pixel. As will be described shortly, in a rolling-shutter case where multiple pixels values form a given line are combined into a single sample per line, the principle can also be applied in one dimension on a per line basis, i.e. E=E_{(y)}, λ=λ_{(y)}, etc.

The following describes an equalization process which the decoder 14 is configured to perform prior to decoding the coded light message from the modulations. The principle is explained below for a scenario without motion. To accommodate scenarios with relative motion between the light source 10 and the camera 12 (either because the light source 10 moves or because the camera 12 moves, or both), the decoder 14 may apply a motion compensation algorithm to compensate for this motion. I.e. the motion compensation ensures that each portion of the frame area (e.g. each pixel or line) captures the same part of the light source 10 from each captured frame to the next. Otherwise if there is no motion present, it will be the case anyway that each portion of the frame area (e.g. pixel or line) captures the same part of the light source 10 from each frame to the next.

In the case of equalizing individual pixels, the equalization is determined based on measuring a set of pixel values at a given pixel position over multiple frames, each value in the set being measured from a different frame at a different respective frame timestamp (time index). This is then repeated over the footprint 10′ of the coded light source 10, i.e. such a set of values is collected for each pixel within the frame area 16 where the footprint 10′ is present.

For each pixel position, the values in the respective set represent different momentary values of λ_{(x,y)}(1+s_{(nTline)}) where λ is fixed over time, but s_{(nTline)} differs as it represents the signal at different line timestamps Tline. Pixel values can be corrected when, based on the set of values, a term can be calculated which looks like λ_{(x,y)}(1+C). The recovered modulation-related term C should be the same for every pixel location. In this case the pixel values P can be equalized by applying the factor 1/(λ_{(x,y)}(1+C)) to the respective pixels, with the end result (1+s_{(nTline)})/(1+C). Now the modulation carrier is fixed for all pixels.

C can, for example, be the long term mean of the modulated signal s. A disadvantage of this is that the set of values (i.e. number of frames) will need to be relatively large to be able to calculate such a property. A property which requires a much smaller set of values is the amplitude of s. This property can be used as long as the modulation amplitude is constant.

The following describes an example of the equalization principle based on using the modulation amplitude.

By way of illustration consider the case where the signal s takes the form of a sinewave, m*sin(ωnTline). To keep the example intuitive, consider also the case where only a single sample is taken per line 18 of the rolling-shutter camera 12, e.g. because the pixels of each line are condensed into a single sample per line. λ now depends only on the y position. In the example given, the normalized light intensity I may be expressed as:

I(nTline)=(1+m*sin(ωnTline))

where m is the modulation index, i.e. the amplitude of the modulation in the emitted light intensity. For illustrative purposes, consider now the case where m=0.1, y spans the range [0 . . . 479], and λ (y) ramps linearly from 0 to 1 over the range from y=0 to y=479.

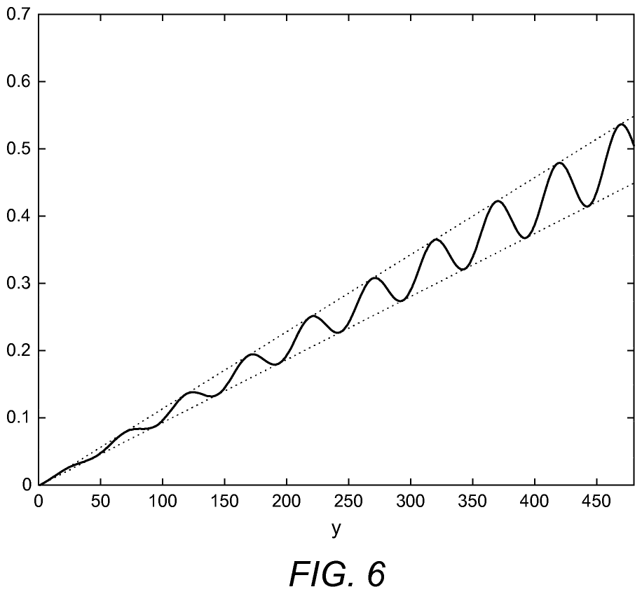

The plot in FIG. 6 below shows the per-line sample values according to λ_{(y)}+m*sin(ωnTline)) for y positions 0 to 479 on the horizontal axis.

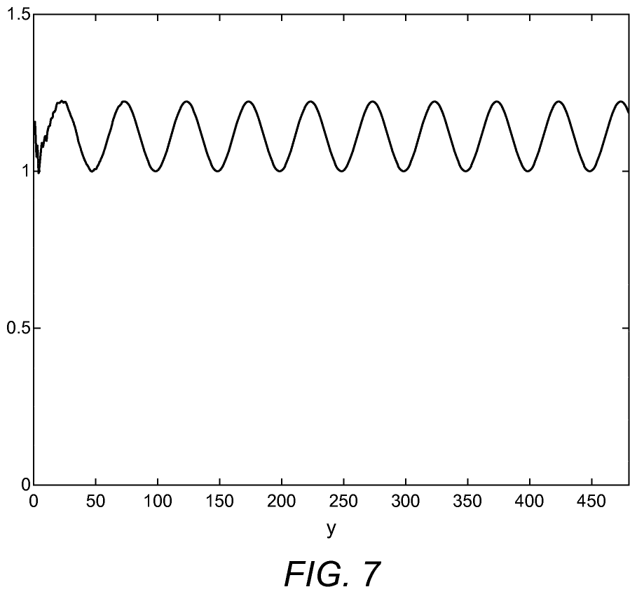

To be able to equalise based on the modulation amplitude, a parameter indicative of the amplitude needs to be determined for every y position. According to embodiments of the present disclose, the decoder 14 is configured to measure the upper and/or lower envelopes of the signal as a measure of its amplitude. The upper and lower envelopes are indicated by the dotted lines in the graph of FIG. 6. The lower envelope can be described by λ_{(y)}(1−m) and the upper envelope can be described by λ_{(y)}(1+m). Hence by dividing by the lower envelope, the decoder 14 can cancel out the effect of the non-uniformity λ_{(y)} and thereby equalize the image to (1+m*sin(ωnTline))/(1−m) as shown in the plot of FIG. 7. Or alternatively, by dividing by the upper envelop, the decoder 14 can equalize to (1+m*sin(ωnTline))/(1+m).

The following describes a process by which the decoder 14 may estimate the envelope. As described above, in general it may be assumed the values of λ are uncorrelated (the ramp shape in FIG. 6 is only for illustrative purposes). For this reason the decoder collects, for each sample position y, a set of sample values at different frame timestamps. I.e. for a given line at position y, a different sample value is collected from each of multiple images. In the example below a set of five values or images is collected. Carrying on the example form FIGS. 6 and 7, FIG. 8 shows the five different spatial signals that appear across the lines of the rolling-shutter camera, each of these five signals corresponding to a different one of a series of five captured frames, with each signal representing a different instance of the received signal constructed from a respective one of the set of five sample values for each line.

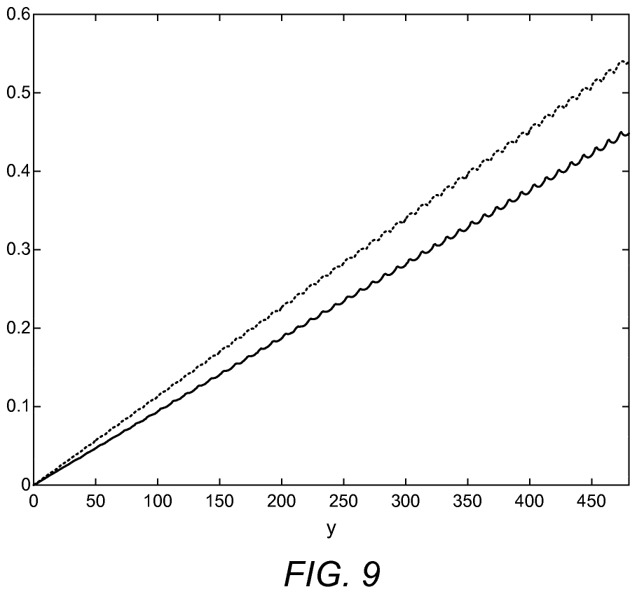

Taking the maximum of each data set gives the upper envelope, and taking the minimum gives the lower envelope. This is shown in FIG. 9.

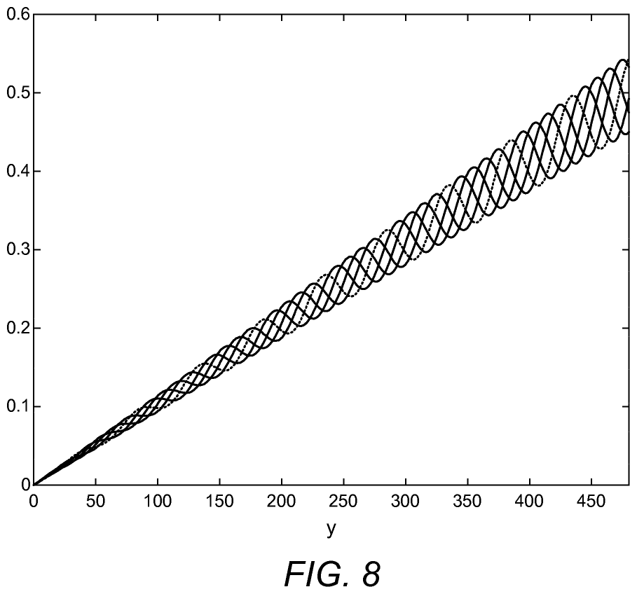

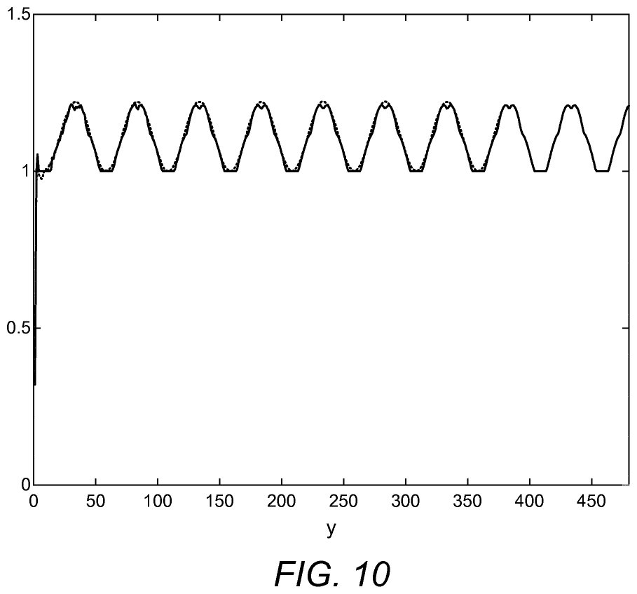

By using the lower envelope of FIG. 9 to equalize the image from which the dotted signal instance of FIG. 8 was sampled, the decoder 14 thus obtains the equalized signal shown in FIG. 10. The sinewave has small distortion due the ripple in the estimated lower envelope.

In the example given above, each data set gives the envelope at an acceptable accuracy. There are, however, situations where the accuracy of the algorithm deteriorates. In embodiments therefore, the decoder 14 is configured to apply a refinement to the estimation of the envelope, as described in the following. Again the example is illustrated based on collecting a set of five sample values per line and detecting the envelope based on these samples.

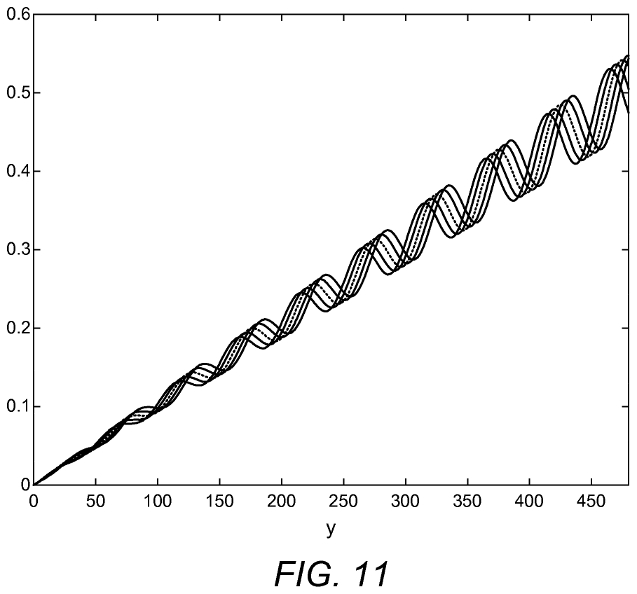

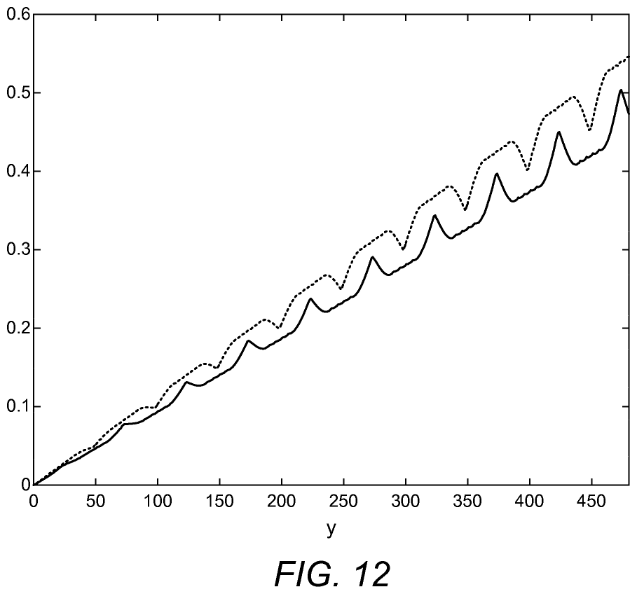

FIGS. 11 and 12 show plots corresponding to those of FIGS. 7 and 8, but wherein the phase of the spatial signals drifts only very slowly from one frame to the next. This occurs when the modulation frequency is very close to being an integer multiple of the frame rate. As can be seen from FIG. 12 therefore, the envelope constructed from the five samples per line is not a very accurate representation of the true amplitude of the modulation, at least not at all points. Instead it contains a large ripple which, if used for equalization at those points, will result in a poor equalization that does not very well factor out the effect of λ_{(y)}.

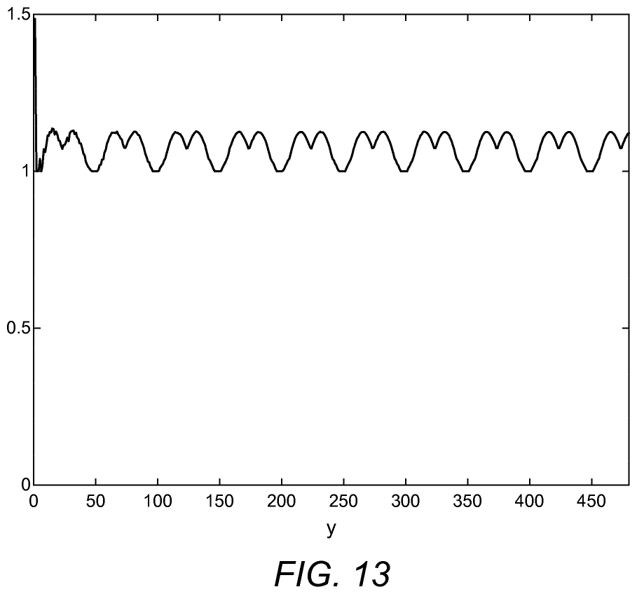

FIG. 13 shows the result of using the lower envelope of FIG. 12 to equalize the image from which the dotted signal instance in FIG. 11 was obtained, based on the same procedure described previously in relation to FIGS. 8 to 10. The sinewave is heavily distorted due to large errors in the estimated envelope. One way to solve this is to increase the size of the dataset from five to a much higher value. This basically means collecting more images with the consequence of increased detection time. It would therefore be desirable to find an alternative solution that does not necessarily rely on collecting a large dataset.

Looking at the detected upper and lower envelope of FIG. 12 in more detail, it turns out there is in fact enough information to perform the equalization correctly, because the upper and lower envelope are alternately correct. I.e. one or the other of the upper envelope (but not both at the same time) still always gives a good representation of the signal amplitude. In embodiments of the present disclosure therefore, the decoder 14 is configured to use one of the upper and lower envelopes to equalize some parts of the frame area 16, and the other envelope to equalize the other parts of the frame area. In embodiments, this is achieved by reconstructing one correct envelope from the upper and lower envelope.

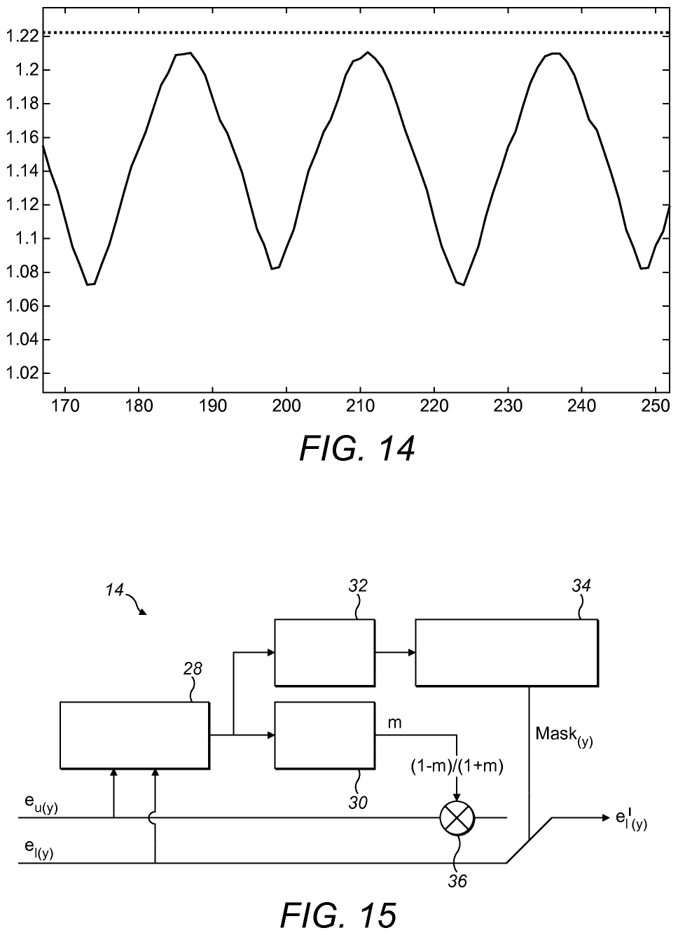

Consider the following relationship:

$${envelope\_ratio}_{( y )} = \frac{{e}_{u ( y )}}{{e}_{l ( y )}} = \frac{{λ}_{y} ( 1 + m )}{{λ}_{y} ( 1 - m )} = \frac{1 + m}{1 - m} = c$$

where eᵤ is the upper envelope and eₗ is the lower envelop. As the λ(y) term disappears the ratio is constant and the ratio value depends only on the modulation index m. This value is maximum when both the estimated upper and lower envelope are valid (i.e. when both are a good representation of the true signal amplitude), and would be constant of both envelopes were always valid. However, when one of the envelopes is not valid then the ratio will drop to a lower value. FIG. 14 shows the envelope ratio as a function of y based on the example of FIGS. 11 and 12.

From this curve the decoder 14 can estimate two properties. Based on the peak values where it is assumed both the upper and lower envelopes are correct, the modulation index m can be retrieved. The local minima on the other hand indicate points where the estimated envelopes have the maximum estimation error.

The block diagram of FIG. 15 shows functional elements of the decoder 14 for creating a reconstructed lower envelope e_{l(y)}′ which is constructed out of valid parts from both the input envelopes e_{u(y)} and e_{l(y)}.

The elements comprise a first functional block 28 which may be labelled “calculate envelope ratio”, a second functional block 30 which may be labelled “detect modulation index”, a third functional block 32 which may be labelled “detect local ratio minima”, a fourth functional block 32 which may be labelled “create envelope selection mask”, and a multiplier 36.

The first functional block 28 calculates the envelope ratio, as a function of y, based on the input upper and lower envelopes e_{u(y)} and e_{l(y)}, and outputs the calculated envelope ratio to each of the second functional block 30 and the third functional block 32.

The second functional block 30 determines the modulation index m based on the calculated envelope ratio. As described previously, at the peaks of the envelope ratio as plotted against y (see FIG. 14), both the upper and lower envelope are assumed to be correct and consequently the relation envelope_ratio=(1+m)/(1−m) can be used. For completeness, note that the algorithm does not necessarily need to compute m explicitly. Rather, it only needs to determine the envelope ratio (1−m)/(1+m) (from which m could be unambiguously computed but does not need to be to perform the equalization).

The third functional block 30 detects the minima in the envelope ratio as plotted against y and indicates the locations of these minima (i.e. the troughs) to the third functional block 32. The third functional block determines, for a region in the received signal around each of these troughs in the envelope ratio, which of the upper and lower envelopes is valid and therefore which should be used for the equalization. This selection, as a function of spatial position y, may be referred to herein as the selection mask.

To reconstruct a single valid version of one of the lower and upper envelopes, then where the other envelope is the only valid envelope, the other envelope is multiplied by the true ratio of the one to the other (as determined by the first functional block based on the peaks in the measured version of the ratio). That is, if reconstructing the lower envelope, the input upper envelope e_{u(y)} is multiplied by (1−m)/(1+m) at least in the regions where the input upper envelope e_{u(y)} is the only valid envelope, and the selection mask determines where to form the reconstructed lower envelope eₗ′_{(y)} from the input lower envelope e_{l(y)} as-is and where instead to form the reconstructed lower envelope eₗ′_{(y)} based on the input upper envelope, i.e. from e_{u(y)}(1−m)/(1+m). The decoder 14 then equalizes the received image by dividing the received values (in this case line sample values) by the reconstructed lower envelope eₗ′_{(y)} across the frame area 16 as a function of spatial position within the frame area.

Equivalently, if reconstructing the upper envelope, the input lower envelope e_{l(y)} is multiplied by (1+m)/(1−m) at least in the regions where the input lower envelope e_{l(y)} is the only valid envelope, and the selection mask determines where to form the reconstructed upper envelope from the input upper envelope e_{u(y)} as-is and where instead to form the reconstructed upper envelope based on the input lower envelope, i.e. from e_{l(y)}(1+m)/(1−m). The decoder 14 then equalizes the received image by dividing the received values by the reconstructed lower envelope eₗ′_{(y)} across the frame area.

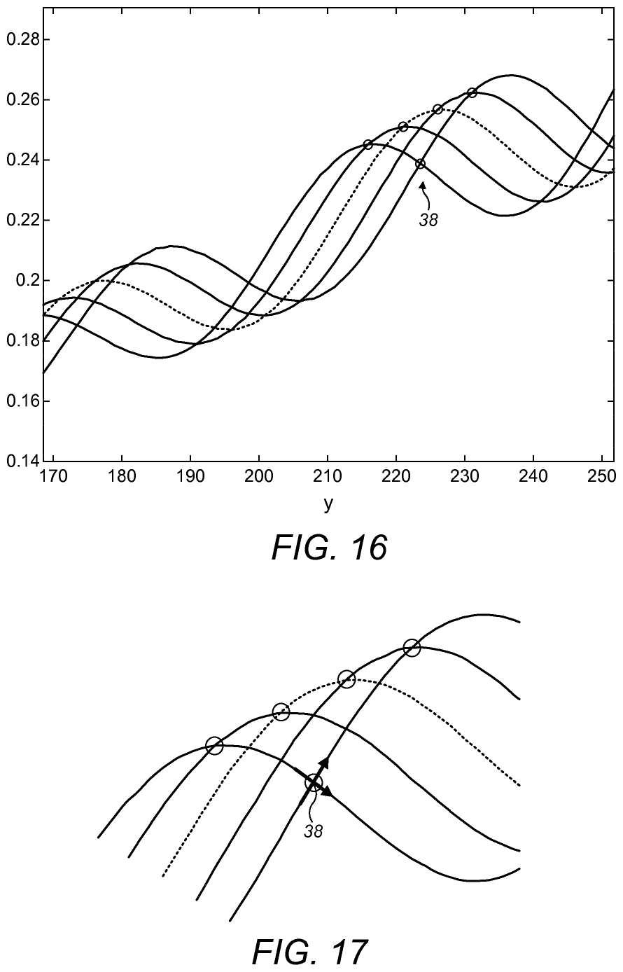

Note that no correlation has been assumed between the λ values for the described algorithm, and this also holds for the creation of the selection mask creation. To explain the creation of the selection mask further, consider the five element dataset collection but “zoomed in” on a piece of the envelope ratio (y) as shown in FIG. 16.

Construction of the envelopes depends on how each individual signal evolves in time. In the above-described scenario it can be see that there are situations where all signal instances are located at approximately the same position. This means that at any given point, there is one very reliable and stable envelope and one envelope which is constructed out of signals which are in transition.

As a selection criterion for the reliable envelope, embodiments of the present disclosure provide a technique which is based on the assumption that when the ratio of the upper and lower envelopes is substantially below its maximum, then this means one of the upper and lower envelopes is currently constructed out of signals that are in transition. This method works well for bandlimited modulation. As a starting point, the disclosure herein introduces the concept of a “takeover” feature, an example of which is labelled 38 in FIG. 16. In case of, for example, the lower envelope, a take-over point occurs when the minimum at position y and y+1 is defined by a different signal instance (i.e. a signal corresponding to a different frame timestamp). In other words the minimum is taken over by another spatial signal. Similarly for the upper envelope, a take-over point occurs when the maximum at position y and y+1 is defined by a different signal instance, i.e. the maximum is taken over by another spatial signal.

When a local minimum is detected in the envelope ratio, the decoder 14 operates according to an assumption that it is likely that one of the envelopes e_{u(y)}, e_{l(y)} is constructed out of signals that are in transition. So at that local minimum of envelope ratio, a takeover feature is also to be expected for one of the upper or lower envelope. If one envelope has exactly a takeover feature at that point while the other one has not, the decoder selects the latter envelope as reliable. The selected envelope is also used for a region around the exact point of the minimum (e.g. a predetermined window of space around that point).

At some times, both envelopes may contain a takeover feature at the specific y position where the minimum in the envelope ratio occurs. To accommodate such a case, the algorithm may be extended by using the takeover speed which is the slope difference at a takeover point. This is illustrated in FIG. 17. A slope is defined as (pixelval_{(y+1)}-pixelval_{(y)})/Δy. The take-over speed is defined as abs(Slope1-Slope2).

When comparing the takeover speed for the two envelopes, the envelope constructed out of signals instances which are in transition will have a higher takeover speed. Hence the decoder 14 is configured to declare that envelope as the bad envelope, and to select the other for use in the equalization.

This criterion is independent of the actual λ. More specifically, the individual take-over speed values are dependent on the actual λ(y) and λ(y+1) but the ratio of the take-over speed values remains constant. I.e. the one with the lowest take-over-speed is the reliable one, and the actual λ does not play a role in which is the lowest.

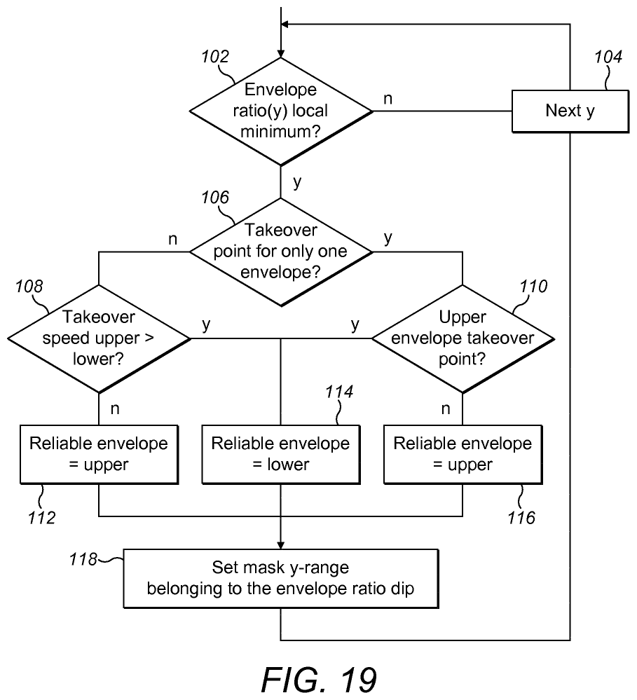

According to everything described above, there has thus been described a mechanism for selection of a reliable envelope for use in performing equalization to accommodate a non-uniform light source. The selection, based on a local minimum point of the envelope ratio, is valid for the complete duration of the ratio dip. A summary of the reliable envelope selection process is shown in the flowchart of FIG. 19. The process is carried out by the decoder 14 prior to the actual decoding of the message from the equalized version of the captured image.

At step 102 the process determines whether, at position y, the envelope ratio has a local minimum. If no the process proceeds to step 104 where it proceeds to the next value of y (i.e. the next position) to be considered, then loops back to step 102. Note that the envelope will also be quite bad be reconstructed in a window a few samples around the minimum as well (e.g. within a predetermined number of samples).

If on the other hand at step 102 it is determined that there is a local minimum, the process proceeds to step 106 where it is determined whether a take-over feature exists at the current position for only one of the upper and lower envelopes. If so, the method proceeds to step 110 where it is determined whether the take-over feature occurs in the upper or lower envelope. If the take-over feature occurs in the upper envelope then the process proceeds to step 114 where the lower envelope is declared as the currently reliable envelope, but if it occurs in the lower then the process proceeds to step 116 where the upper envelope is declared as the currently reliable envelope.

If on the other hand it is determined at step 106 that there are take-over points in both the upper and lower envelopes at the current position y, then the process proceeds to step 108 where it is determined whether the take-over speed is greater in the upper or lower envelope. If greater in the upper envelope, the process proceeds to step 114 where the lower envelope is declared as the currently reliable envelope, but if greater in the lower envelope then the process proceeds to step 116 where the upper envelope is declared as the currently reliable envelope.

Whichever envelope is declared as reliable at the current position, via whichever branch of the process this decision is arrived at, at step 118 the process then sets the selection mask to select the decided envelope for use in the equalization at the present position y.

The process then proceeds to step 104 where it proceeds to the next position, i.e. next value of y, and repeats the process over again until all positions y under consideration have been processed (e.g. all positions y within the frame area covering the footprint 10′ of the light source 10).

It will be appreciated that the above embodiments have been described by way of example only.

For instance, note that the techniques described above will also work with blanking and are only described here without blanking for illustrative purposes. When including blanking one can instead define y_size as the vertical size including the blanking part. But when entering y positions inside the blanking part (according to y=n modulo y_size), P(x,y) does not appear in the image, so those samples are not used.

Further, the applicability of the techniques disclosed herein is not limited to rolling-shutter cameras, and is not limited to the 1D case exemplified above. The two-dimensional case can be obtained by adding an x direction (λ(x,y), etc.) in the above equations. Preferably however, pixels with repeated information are combined into groups in a one or two dimensional array (e.g. a single line contains information for a single time instant). This improves the signal-to-noise ratio (SNR).

In the rolling shutter case, the time vary-component changes per line. So for each line, the pixels are combined over the line to improve SNR. This also leads to a combined λ per line. By equalisation the disclosed method undoes the non-uniformity of the combined λs over the lines. In the global shutter case on the other hand, the time varying-component changes per image. In this case all the pixels 10′ covering the light source 10 may be combined to improve SNR (as they all contain the same modulation). For a light source comprising a single, unitary coded light element, now one obtains a single combined λ per image, rather than per line. As this λ is fixed for every image, the variation between images is the purely due to the modulation, so no equalisation required. Nonetheless, there are situations in which equalization may be required even with global shutter capture. For instance, consider the scenario where the light source 10 comprising multiple elements (e.g. multiple LEDs or groups of LEDs) where every individual element (e.g. individual LED or LED group) transmits a different component. In that situation one cannot just combine all the pixels 10′ covering the light source 10. Therefore in accordance with embodiments disclosed herein, the decoder 14 may be configured to perform 2D equalization and perform spatial separation of the coded light components afterwards based on the equalized image. This could for example be a VLC communication system designed especially for global shutter cameras.

Other variants and other applications may become apparent to a person skilled in the art once given the disclosure herein. The scope of the present disclosure is not limited by the above-described embodiments but only by the accompanying claims.

1. A device comprising a decoder for decoding a signal modulated into visible light emitted by a light source, the decoder being configured to perform operations of:
receiving a series of frames captured by a camera, each of said series of frames capturing an image of the light source at a different time index;
from each of said series of frames, sampling a plurality of portions of the frame that capture part of the light source, and thereby, over the series of frames, obtaining from each respective one of the portions a respective temporal series of samples;
for each of said plurality of portions, determining a respective value of a property that smooths out temporal variations within the respective series of samples;
using the respective value of said property to determine a respective equalization to apply to each of the portions in order to correct for a spatial non-uniformity in the light source; and
applying the respective equalization to each of said portions and detecting the coded light signal based thereon.

2. The device of claim 1, wherein said property is an average of the respective series of samples.

3. The device of claim 1, wherein said property comprises an upper or lower amplitude envelope of the respective series of samples.

4. The device of claim 3, wherein the decoder is configured to perform the determination of said equalization by, for each of said plurality of portions:
determining one of the upper or lower amplitude envelope to be valid in that it gives a more representative indication of a true amplitude of the modulation, and
determining the equalization to apply based on the valid envelope.

5. The device of claim 4, wherein the decoder is configured to perform the determination of said equalization by:
a) evaluating a metric comparing the upper amplitude envelope to the lower amplitude envelope across each of the plurality of portions,
b) based thereon determining a value of said metric at which said metric indicates that the upper amplitude envelope is greatest compared to the lower amplitude envelope, and
c) reconstructing one of the upper or lower amplitude envelopes across said plurality of portions, by, where said one of the upper or lower amplitude envelopes is not the valid envelope, reconstructing said one of the upper or lower amplitude envelopes based on the other of the upper and lower amplitude envelopes and the value at which said metric indicates the greatest difference between the upper and lower amplitude envelopes, wherein the equalization is performed based on the reconstructed upper or lower amplitude envelope.

6. The device of claim 5, wherein the decoder is configured to perform operations a) to c) by:
a) determining a ratio of the upper to the lower amplitude envelope for each of the plurality of portions wherein the ratio oscillates in space across the plurality of portions,
b) determining a maximum of said ratio across the plurality of portions, and
c) reconstructing one of the upper or lower amplitude envelopes across said plurality of portions, by, where said one of the upper or lower amplitude envelopes is not the valid envelope, reconstructing said one of the upper or lower amplitude envelopes by multiplying or dividing, accordingly, the other of the upper and lower amplitude envelopes by the determined maximum of said ratio, wherein the equalization is performed based on the reconstructed upper or lower amplitude envelope.

7. The device of claim 4, wherein the decoder is configured to perform the determination as to which of the upper and lower amplitude envelopes is valid by:
across the plurality of portions, determining points at which a ratio of the upper to the lower amplitude envelope is minimum, and for each respective one of said points, determining which is spatially closest to the respective point out of: i) a feature of the lower amplitude envelope whereby, from one of the portions to an adjacent one of said portions, the time index corresponding to the greatest value amongst the respective series of samples differs, in which case the upper amplitude envelope is determined to be the valid envelope in a region around the respective point, or ii) a feature of the upper amplitude envelope whereby, from one of the portions to an adjacent one of said portions, the time index corresponding to the greatest value amongst the respective series of samples differs, in which case the lower amplitude envelope is determined to be the valid envelope in a region around the respective point.

8. The device of claim 7, wherein the decoder is configured so as, when the features of both i) and ii) occur at the same point, to determine for each of i) and ii) a change in slope of the signal from the time index of the one portion to the time index of the adjacent portion, and to select as the valid envelope that one of the upper and lower amplitude envelopes which has the greatest change in slope.

9. The device of claim 1, wherein the camera is a rolling shutter camera which captures each frame in a temporal sequence of lines, and wherein each of said portions is a respective one of the lines sampled by combining individual pixels values from the respective line.

10. The device of claim 1, wherein each of said portions is a pixel, or a group of pixels in a two-dimensional array of such groups.

11. The device of claim 1, further comprising a motion compensator arranged to compensate for relative motion between the light source and the camera.

12. A system comprising the device of claim 1, and further comprising the camera and the light source.

13. The system of claim 12, wherein the light source takes the form of a luminaire and said light takes the form of illumination for illuminating an environment.

14. A method of decoding a signal modulated into visible light emitted by a light source, the method comprising:
receiving a series of frames captured by a camera, each of said series of frames capturing an image of the light source at a different time index;
from each of said series of frames, sampling a plurality of portions of the frame that capture part of the light source, and thereby, over the series of frames, obtaining a respective temporal series of samples from each respective one of the portions;
for each of said plurality of portions, determining a respective value of a property that smooths out temporal variations within the respective series of samples;
using the respective value of said property to determine a respective equalization to apply to each of the portions in order to correct for a non-uniformity in the light source; and
applying the respective equalization to each of said portions and detecting the coded light signal based thereon.

15. A computer program product for decoding a signal modulated into visible light emitted by a light source, the computer program product comprising code embodied on a computer-readable medium and/or being downloadable therefrom, and the code being configured to perform operations of:
receiving a series of frames captured by a camera, each of said series of frames capturing an image of the light source at a different time index;
from each of said series of frames, sampling a plurality of portions of the frame that capture part of the light source, and thereby, over the series of frames, obtaining a respective temporal series of samples from each respective one of the portions;
for each of said plurality of portions, determining a respective value of a property that smooths out temporal variations within the respective series of samples;
using the respective value of said property to determine a respective equalization to apply to each of the portions in order to correct for a non-uniformity in the light source; and
applying the respective equalization to each of said portions and detecting the coded light signal based thereon.
